(19) United States
(12) Patent Application Publication
(10) Pub. No.: US 2024/0184921 A1
(43) Pub. Date: Jun. 6, 2024

(54) ANONYMOUS SUBSCRIPTION

(71) Applicant: Donaldo Floriano Rodrigues, Monroe, NJ (US)

(72) Inventor: Donaldo Floriano Rodrigues, Monroe, NJ (US)

(21) Appl. No.: 18/073,620

(22) Filed: Dec. 2, 2022

(51) Int. Cl. G06F 21/62; G06Q 30/01

(52) U.S. Cl. CPC G06F 21/6254; G06Q 30/01

(57) ABSTRACT

A computer software implemented method and/or apparatus which may include receiving a request from a first user human being to subscribe to a first vendor; responsive to receiving the request, using an online system computer software platform to create a first anonymous subscription to one or more services of the first vendor without revealing, to the first vendor, any identifying information for the first user human being which exists independent of the online system computer software platform; responsive to creating the first anonymous subscription, generating a first unique identifier that links the first vendor to the first user human being; storing the first anonymous subscription in computer memory of the online computer software platform; storing the first unique identifier in computer memory of the online computer software platform; and associating, in computer memory of the online computer software platform, the first unique identifier with the anonymous subscription.

### FIELD OF THE INVENTION

This invention relates to entities subscribing to other entities.

### BACKGROUND OF THE INVENTION

Everybody is wary of subscribing to a business (henceforth called vendors) on the internet using their personal details (name, email, phone number etc.) because they are afraid that their personal data may be shared by the vendors with others. Alternatively, the data might just be stolen from the vendors' system. Stolen data can lead to identity theft at worst and lot of spam/phishing emails/calls from various other vendors or unscrupulous actors. Once the personal details including emails and phone number and email are out in the open, there is no fool proof way to stop others from sending you spam emails or mailings. Most vendors let you unsubscribe, but that relies on the vendors honoring the request not to send you any more communication (emails, text messages etc.). In other words, the user has no control over the unsubscribe process.

Consequently, it is desirable to have a system where users can subscribe to vendors without giving away any personal information and have the ability to unsubscribe anytime at will without making a request to the vendor. Since the vendor doesn't store nor has access to any personal data of the user, the risk to the user of any data theft at the vendor site is minimal.

### SUMMARY OF THE INVENTION

One or more embodiments of the present invention, provide a method, apparatus, and/or system which allows entities to subscribe anonymously to other entities. In one example, unique identifiers are used to link two entities and the subscribed entity using that identifier to communicate with the subscriber entity.

An online method, system, and apparatus (hereinafter “platform”) is configured to allow users and vendors to register as a different class of entities and then allow the users to subscribe to any vendor anonymously.

In at least one embodiment, the vendor can decide whether or not it will allow users to subscribe. Furthermore, if it allows subscribers, it can also choose to have each subscriber approved individually rather than automatically approving all subscribers. The process of subscribing to a vendor generates a unique identifier or subscriber identification (hereinafter “SubscriberId”) that links the vendor to the subscriber.

In at least one embodiment, a vendor uses the subscriberId to identify the subscriber to whom it wants to send communication via the platform. Communication with the subscriber, in at least one embodiment, is in the form of various types of messages supported by the platform. The SubscriberId can only be used by the vendor and subscriber for whom it was generated. If any other vendor tries to use the SubscriberId (due to theft or distribution) for any purpose, the platform will deny the request. Additionally, in such a situation, the platform can notify the rightful owner of the subscriberId of a potential data breach.

The user can unsubscribe from the vendor at any time. The process of unsubscribing marks the SubscriberId as “Unsubscribed” so that the vendor can no longer use it to communicate with the subscriber. In at least one embodiment, the user can choose to resubscribe to the vendor at any time so long as the vendor allows resubscription.

In at least one embodiment, an apparatus is provided comprising: one or more computer processors; and one or more computer memories.

In at least one embodiment, of the present application, the one or more computer memories have stored therein an online system computer software platform; wherein the one or more computer processors are configured to implement the online system computer software platform; wherein the online system computer software platform is configured to receive a request from a first user human being to subscribe to a first vendor; wherein responsive to receiving the request, the online system computer software platform is configured to create a first anonymous subscription to one or more services of the first vendor without revealing, to the first vendor, any identifying information for the first user human being which exists independent of the online system computer software platform; and wherein responsive to creating the first anonymous subscription, the online system software platform is configured to generate a first unique identifier that links the first vendor to the first user human being.

In one or more embodiments of the present application, the online system computer software platform is configured to store the first anonymous subscription in computer memory of the online computer software platform; wherein the online system computer software platform is configured to store the first unique identifier in computer memory of the online computer software platform; and wherein the online system computer software platform is configured to associate, in computer memory of the online computer software platform, the first unique identifier with the anonymous subscription.

In one or more embodiments of the present application, the online system computer software platform is configured to receive a first set of one or more communications from the first vendor at the online system computer software platform, wherein the first set of one or more communications include the first unique identifier; wherein the online system computer software platform is configured to determine if the first unique identifier is located in the computer memory of the online computer software platform; and wherein the online system computer software platform is configured so that if the first unique identifier is located in the computer memory of the online computer software platform: (a) the online system computer software platform retrieves data associated with the first user human being from computer memory of the online computer software platform; and (b) stores the first set of one or more communications in an account associated with the first user human being on the online computer software platform.

The online system computer software platform may be configured so that if the first unique identifier is located in the computer memory of the online system computer software platform, the online system computer software platform sends a first notification to a user computer device through which the first user human being is indicated as being logged in and connected to the online system computer software platform.

The online system computer software platform may be configured to receive a request from the first user human being to unsubscribe to the first vendor; and responsive to receiving the request from the first user human being to unsubscribe to the first vendor, the online system computer software platform removes the first anonymous subscription to the one or more services of the first vendor and the first unique identifier from the computer memory of the online system computer software platform.

In at least one embodiment, instead of removing the first anonymous subscription from the computer memory, the online system computer software platform may mark the first anonymous subscription in computer memory as “unsubscribed” and not remove it.

Generally, in at least one embodiment, the first user human being is one of a plurality of user human beings, and the first vendor is one of a plurality of vendors.

In at least one embodiment, a computer software implemented method is provided comprising the steps of: receiving, at an online system computer software platform executed by computer hardware, a request from a first user human being to subscribe to a first vendor; responsive to receiving the request, and using the online system computer software platform to create a first anonymous subscription to one or more services of the first vendor without revealing, to the first vendor, any identifying information for the first user human being which exists independent of the online system computer software platform.

The method may also include, responsive to creating the first anonymous subscription, generating a first unique identifier that links the first vendor to the first user human being; storing the first anonymous subscription in computer memory of the online computer software platform; storing the first unique identifier in computer memory of the online computer software platform; and associating, in computer memory of the online computer software platform, the first unique identifier with the anonymous subscription.

The method may further include receiving a first set of one or more communications from the first vendor at the online system computer software platform, wherein the first set of one or more communications include the first unique identifier; determining if the first unique identifier is located in the computer memory of the online computer software platform; if the first unique identifier is located in the computer memory of the online computer software platform: (a) retrieving data associated with the first user human being from computer memory of the online computer software platform; and (b) storing the first set of one or more communications in an account associated with the first user human being on the online computer software platform.

In at least one embodiment of the present application, if the first unique identifier is located in the computer memory of the online computer software platform, the method further includes sending a first notification to a user computer device through which the first user human being is indicated as being logged in and connected to the online computer software platform.

The method may also include receiving, at the online system computer software platform executed by the computer hardware, a request from the first user human being to unsubscribe to the first vendor; and responsive to receiving the request from the first user human being to unsubscribe to the first vendor, using the online system computer software platform to remove the first anonymous subscription to the one or more services of the first vendor and the first unique identifier from the computer memory of the online system computer software platform.

In at least one embodiment, instead of removing the first anonymous subscription from the computer memory, the online system computer software platform may mark the first anonymous subscription in computer memory as “unsubscribed” and not remove it.

In at least one embodiment, a computer software implemented method is provided comprising the steps of: receiving, at an online system computer software platform executed by computer hardware, a request from a first user human being to subscribe to a first vendor; and responsive to receiving the request, using the online system computer software platform to create, if a first set of predetermined criteria specified by the first vendor and stored in computer memory of the online system computer software platform is met, a first anonymous subscription to one or more services of the first vendor without revealing, to the first vendor, any identifying information for the first user human being which exists independent of the online system computer software platform.

The method may also include, responsive to creating the first anonymous subscription, if the first anonymous subscription was created, generating a first unique identifier that links the first vendor to the first user human being; storing the first anonymous subscription, if the first anonymous subscription was created, in computer memory of the online computer software platform; storing the first unique identifier, if the first anonymous subscription was created, in computer memory of the online computer software platform; and associating, in computer memory of the online computer software platform, the first unique identifier with the anonymous subscription, if the first anonymous subscription was created.

The method may further include receiving a first set of one or more communications from the first vendor at the online system computer software platform, wherein the first set of one or more communications include the first unique identifier, if the first anonyomous subscription was created; determining if the first unique identifier is located in the computer memory of the online computer software platform, if the first anonymous subscription was created; and if the first unique identifier is located in the computer memory of the online computer software platform: (a) retrieving data associated with the first user human being from computer memory of the online computer software platform; and (b) storing the first set of one or more communications in an account associated with the first user human being on the online computer software platform, if the first anonymous subscription was created.

In at least one embodiment, the online system computer software platform determines if the first set of predetermined criteria specified by the first vendor and stored in computer memory of the online system computer software platform is met by comparing information from the request from the first user human being with the first set of predetermined criteria.

The first set of predetermined criteria may include a requirement that the request include a name and/or an address for the first user.

### BRIEF DESCRIPTION OF THE DRAWINGS

FIG. 1 is a simplified block diagram of a system, apparatus, and method in accordance with an embodiment of the invention;

FIG. 2 is a simplified block diagram of various components for use with the system, apparatus, and method of FIG. 1;

FIG. 3 is a flow chart showing operation of the system, apparatus, and method of FIG. 1;

FIG. 4 is a simplified diagram of a first screen or first image which is configured to be displayed on a client device computer in accordance with an embodiment of the present invention;

FIG. 5 is a simplified diagram of a second screen or second image which is configured to be displayed on the client device computer in accordance with an embodiment of the present invention; and

FIG. 6 is a simplified diagram of a second screen or second image which is configured to be displayed on a client device computer in accordance with an embodiment of the present invention.

### DETAILED DESCRIPTION OF THE DRAWINGS

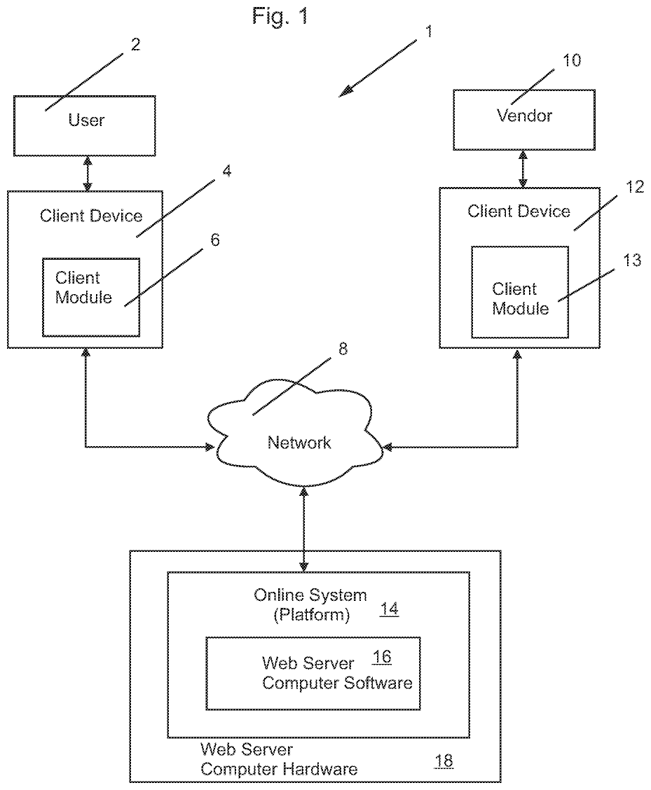

FIG. 1 is a simplified block diagram of a system, apparatus, and method 1 in accordance with an embodiment of the invention.

The system, apparatus, and method 1 of FIG. 1 includes a human user 2, a client device computer 4, a client module 6, a network 8, a vendor or business 10, a client device computer 12, a client module 13, an online system (platform) 14, and a web server 16. FIG. 1, shows the system architecture adapted to support at least one embodiment of the present invention.

Each of the client module 6 and the client module 13 may be a computer software browser, a computer software application, or any computer software that is configured to connect to the web server 16 over the network 8.

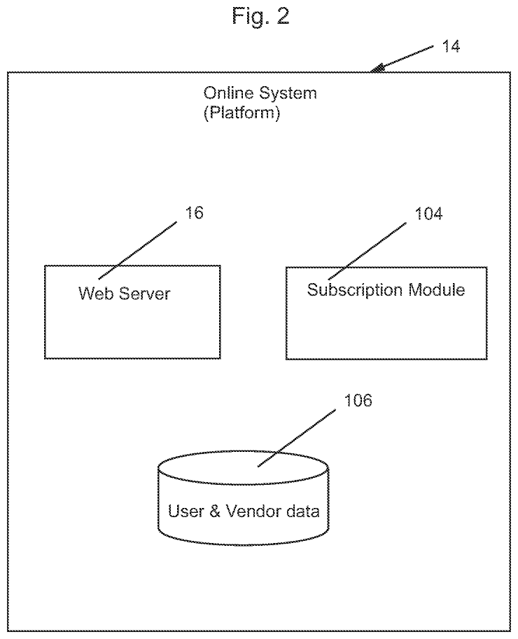

FIG. 2 is a simplified block diagram of the online system (platform) 14, which includes various components for use with the system, apparatus, and method 1 of FIG. 1. The online system (platform) 14 includes web server 16, subscription computer software module 104, and user & vendor database 106. The platform 14, in at least one embodiment, typically may have a lot of other typically known computer software modules required for the platform 14 to function, as would be recognized by one skilled in the art. The subscription module 104, in at least one embodiment, could be integrated into web server computer software 16.

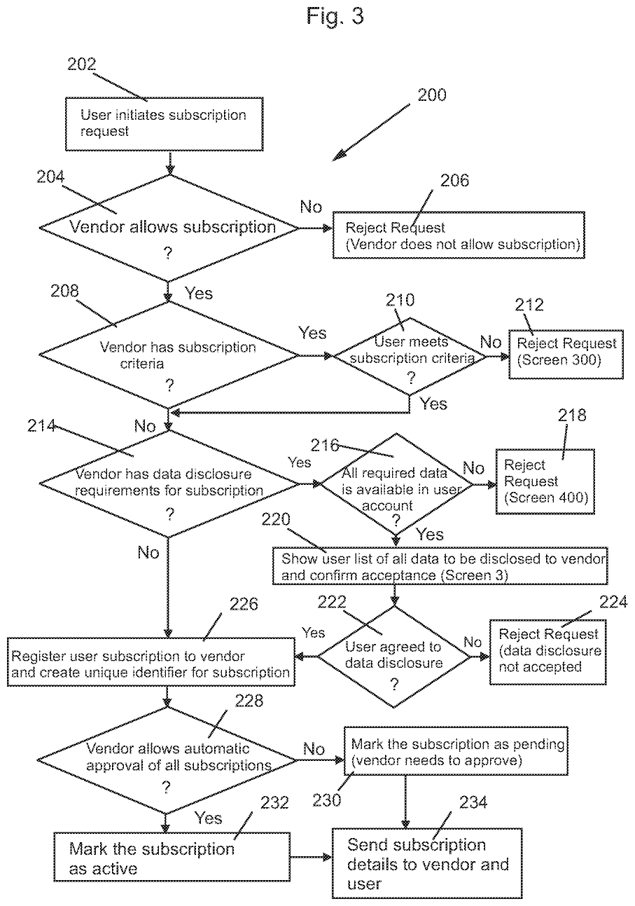

FIG. 3 is a flow chart 200 showing operation of the system, apparatus, and method 1 of FIG. 1. The flow chart 200 includes step 202, which is receiving a user 2 request, at the online system (platform) 14 on web or computer server 16 via the client module 6 on client device 4 over network 8.

At step 204, the vendor 10 may allow or not allow the subscription request of the user 2, by response provided to the online system (platform) 14 on web computer server 16, via client module 13 on client device 12 over network 8. If the vendor 10 does not allow the subscription, the request is rejected at step 206.

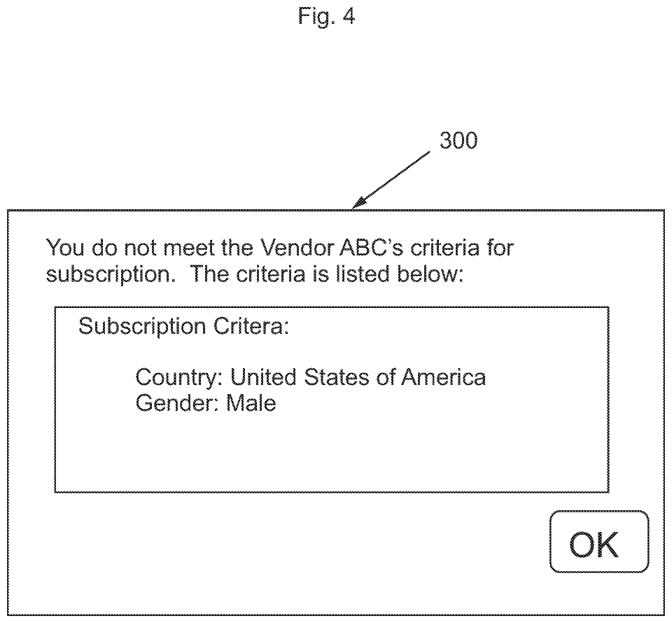

If the vendor 10 allows the subscription at step 204, then the process continues at step 208 where it is determined, by computer software stored in computer memory of the platform 14 and executed by a computer processor of the platform 14, if the vendor 10, has any subscription criteria set. A subscription criteria is any conditions that the user needs to meet to be eligible for subscription. Examples of these conditions include, but is not limited to, the user residing in a particular country, of a particular gender or above/below a certain age. If any subscription criteria is set, then the process continues to step 210 where it is determined, by computer software stored in computer memory of the platform 14 and executed by a computer processor of the platform 14, if the user meets all the criteria. If the user doesn't meet any of the criteria for subscription, then the request is rejected in step 212. An example of the reject message is shown in FIG. 4 referred to as screen 300. If the user meets all the criteria in step 210 or there were no subscription criteria in step 208, then the process continues to step 214.

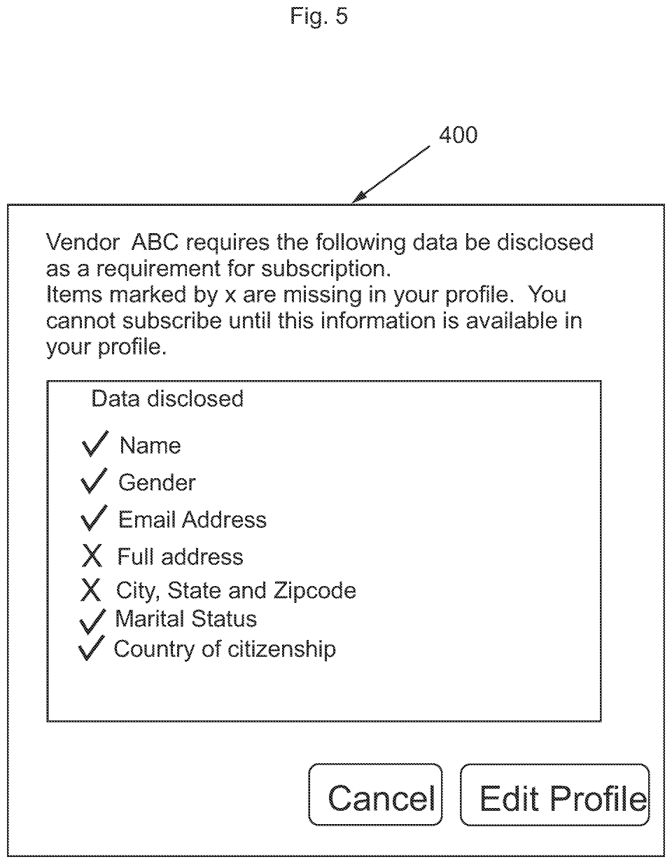

In step 214, it is determined by computer software stored in computer memory of the platform 14 and executed by a computer processor of the platform 14, if the vendor 10 has any data disclosure requirements that the user 2 needs to accept to be able to subscribe to the vendor 10. If there are, then the process continues to step 216 where it is checked by computer software stored in computer memory of the platform 14 and executed by a computer processor of the platform 14, if the user 2 has all the required data available in the user account stored in computer memory of the platform 14. If any of the data is not available for the user 2, then the request is rejected in step 218. An example of the reject message is shown in the FIG. 5, referred to as screen 400. If the vendor 10 has no data disclosure requirements stored in computer memory of the platform 14, in step 214, then the process continues with step 226.

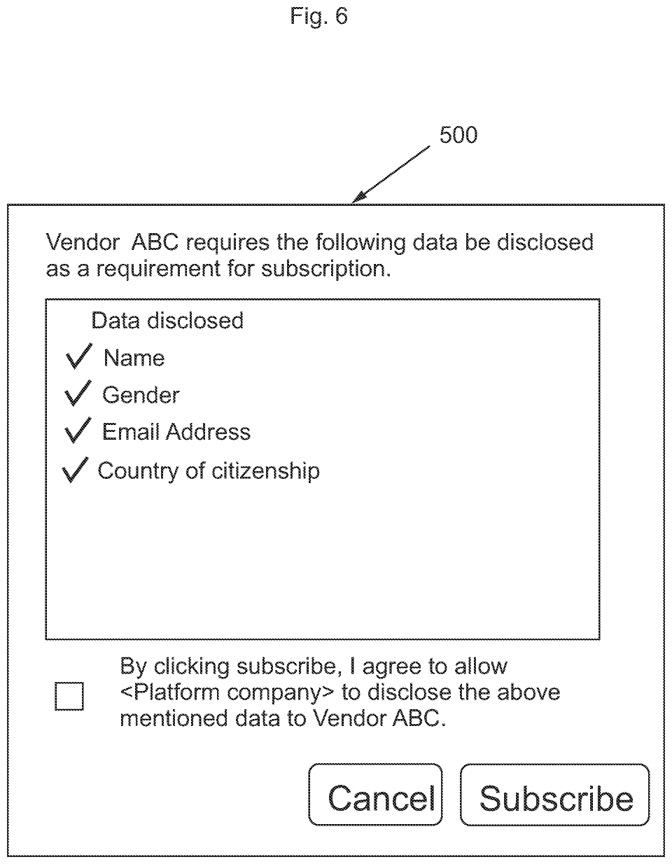

In the step 216 above, if it is determined that user has all data required to be disclosed in the user account, then the process continues to step 220 where a message is shown to the user with all the data that will be disclosed to the vendor. An example of this message is shown in FIG. 6, referred to as screen 500. At this step, the user is required to confirm and accept disclosure of the data listed in the message. In step 222, we determine if the user has accepted the data disclosure requirements in step 220. If the user did not accept, then the request is rejected in step 224. If the user accepts the data disclosure requirements in step 222, then the process continues to step 226.

At step 226 a subscription is registered for the user 2 with a unique identifier (“SubscriberId”) as stored in computer memory of the web computer server 16.

At step 228, shown in FIG. 3, it is determined by a computer processor implementing computer software of the platform 14, if the vendor allows automatic approval of all subscriptions. If that is not the case, then the subscription at step 226 is marked as “pending” in computer memory of the platform 14, at step 230 and will be active only after the vendor approves it via the client module 13 on client device 12. If the vendor allows automatic approval of all subscriptions, the subscription in step 226 will be marked as “active” by the computer processor of the platform 14, in accordance with computer software stored in computer memory, in step 232.

At step 234 the subscription details are sent to the user 2 from the web server 16 via the network 8, the client module 6 and the client device or computer 4. Subscription details are also sent to vendor 10 from the web server 16 via network 8, client module 13 and client device 12.

In at least one embodiment, the network 8 represents the means of communication between a user 2, vendor 10 and the online system (Platform) and/or computer software 14 located on the web computer server 16. In at least one embodiment, the network 8 is the Internet. The network can also utilize dedicated or private communication links (e.g. wide area network “WAN”, metropolitan area network “MAN”, or local area network “LAN”) that are not necessarily part of the Internet. The network 8 may use standard communications technologies and/or protocols.

The web server or computer server 16 accepts requests from client modules 6 and 13 and presents data that is formatted in a way that is understood by the client modules 6 and 13. The data could be formatted like Javascript Object Notation “JSON” or could be web pages or other web content. This forms the basic interface between the platform 14 and user 2, between platform 14 and vendor 10, and other human users having other client computers similar or identical to client device or computer 4 or client device or computer 12.

User 2, vendor 10 and other users and vendors can interact with the online system, platform or computer software 14 through the client module 6 and client module 12 using any device that can connect to the online system 14.

In one embodiment, the client device or computer 4 and similar computers 4 are used by the users for interacting with the online system 14. The client device or computer 12 and similar computers 12 are used by vendors for interacting with the online system or platform 14. Client devices 4 and 12 can be any device that is or incorporates a computer such as a personal computer (PC), a desktop computer, a laptop computer, a notebook, a smartphone, or the like. A computer is a device having one or more general or special purpose processors, memory, storage, and networking components (either wired or wireless). The device executes an operating system, for example, a Microsoft (trademarked) Windows-compatible operating system (OS), Apple (trademarked) OS X or iOS, a Linux distribution, or Google's Android OS. In some embodiments, the client device 4 may use a web browser 6, such as Microsoft (trademarked) Internet Explorer, Mozilla (trademarked) Firefox, Google (trademarked) Chrome, Apple (trademarked) Safari and/or Opera, as an interface to interact with the online system 14. In one embodiment, the client devices 4 and 12 may be configured to be running custom computer software applications that are specially written to connect to and interface with the server 16 on platform 14. Client devices 4 and 12 may be similar hardware devices running different software. Client devices 4 and 12 may also be running the same custom software application that can be configured to run in user mode or vendor mode.

Referring to FIG. 2, in one embodiment the online system or platform 14 comprises a database 106, a subscription module 104 and the web server computer software 16. In at least one embodiment, the web server computer software 16 is computer software that is part of the online system or platform computer software 14, and both software 14 and 16 are stored on computer memory of web server computer hardware 18, are implemented by one or more computer processors of web server computer hardware 18. The client device 4 will generally connect to the web server computer software 16. However, the online platform computer software 14 can have other computer software modules that help platform 14 process information.

Those familiar with online systems will appreciate that the online system 14 will contain other modules appropriate for its functionality (e.g., payments, account management, social networking, banking etc.), but that are not described herein, since they are not directly material to the invention. In addition, conventional elements, such as firewalls, authentication systems, and payment processing systems, network management tools, load balancers, and so forth are not shown as they are not material to the invention. The online system 14 may be implemented using a single computer, or a network of computers, including cloud-based computer implementations. The computers are preferably server class computers including one or more high-performance CPUs and 5G (5^{th} Generation wireless) or higher of main memory, running an operating system such as LINUX (trademarked) or variants thereof.

The operations of the system 14 as described herein can be controlled through either hardware or through computer programs installed in non-transitory computer storage and executed by the processors to perform the functions described herein. The various database stores (e.g., database 106, etc.) are implemented using non-transitory computer readable storage devices, and suitable database management systems for data access and retrieval. The online system 14 includes other hardware elements necessary for the operations described here, including network interfaces and protocols, input devices for data entry, and output devices for display, printing, or other presentations of data. Each user and vendor of the online system 14 is associated with a user profile and vendor profile respectively, which is stored in the database 106; the database 106 is implemented in a database management system, such as a relational database (e.g., MySQL) or a NoSQL database.

Each user 2 on the platform 14 is associated with a user profile which is stored in the database 106. Similarly, each vendor 10 on the platform 14 is associated with a vendor profile that is stored in the database 106. The profiles of user and vendor that were explicitly provided by the user or vendor, may also include information inferred by the online system 14.

The data profile for each user 2 includes multiple data fields, each data field describing one or more attributes of the corresponding user or vendor of the online system 14. Examples of information stored include biographic (e.g., name, date of birth, home address), demographic, and other types of descriptive information, such as work experience, education history, gender, telephone numbers, email address, and the like. The data profile for the vendor 10 generally contains information identifying the business and does not include personal information of the owner or its officers. The database 106 may also maintain references to actions by the corresponding user or vendor performed in the online system 14, such as messages received and read or deleted, subscriptions created, and so forth.

The subscription module 104 handles all subscription related functionality. The subscription module 104 verifies that a user subscription to a vendor, such as vendor 10, doesn't already exist. A vendor, such as vendor 10, can specify data disclosure requirements as a condition for subscription. Examples of personal data items the vendor can require to be disclosed include, but is not limited to, first name, full name, gender, age, date of birth, address, nationality, country of birth, health insurance, education level, tax identification number etc. If the subscription requires data disclosure, then the subscription module 104 checks to see if the required data is available in the user profile and the user has consented to disclosing the said data. If any of the data items is not available in the user profile or the user has not consented to disclosing the data, the subscription module will abandon the subscription process and return an error.

In one embodiment, the subscription module 104 can also be configured to check if the vendor 10 has conditions set up that need to be met to create a subscription. Examples of these conditions include, but is not limited to the user 2 residing in a particular geographical area (residing in a country, residing with a certain distance of the vendor's address etc.), the user 2 being of a particular gender, the user being in a certain age group, the user having education level above a certain minimum etc. If such conditions are set by the vendor, the subscription module 104 is programmed with computer software to check to ensure that the user 2 satisfies all the conditions before proceeding with creating the subscription.

In some embodiments, the vendor 10 can specify a fee, one time or recurring, to charge the user for a subscription. In such a case, the subscription module 104 is programmed to ensure that the platform 14 has collected the fees from the user before creating the subscription.

Once all the data disclosure requirements and conditions are satisfied, the subscription module 104 is programmed to create a subscription of the user 2 to the vendor 10. In one embodiment, the subscription is a database record that uniquely identifies the user as subscribed to the vendor. This record contains a user readable identifier (henceforth called SubscriberId) that uniquely links the user 2 to the vendor 10. If the vendor 10 allows automatic approval of subscriptions, then the subscription record will be marked as “active” in computer memory of the web server computer hardware 18. If not, then the subscription record will be marked as “pending” in computer memory of the web server computer hardware 18 and the subscription will not be active until the vendor 10 approves it.

Whenever the vendor 10 intends to send communications (in the form of messages, email or text, or various items) to the user 2 from the client device 12 to the client device 4, it can request the platform 14 do so by identifying the user with the SubscriberId. Platform 14 will honor the vendor's request only if the subscription is active at that time.

In at least one embodiment, when a user 2 subscribes to a vendor 10, the user 2 has access to all public information about the vendor 10 including knowing the name, address and other details of the vendor. On the other hand, the vendor 10, will preferably have access to only that information that the user 2 has voluntarily agreed to disclose, which in some cases will be nothing, i.e. the user is completely anonymous.

In at least one embodiment, it is possible for a user to subscribe to a vendor 10 with no information. In such a case, the vendor 10 will only have the subscriberId to identify the subscriber and nothing else, not even a name.

In at least one embodiment, the present application provides a method which includes registering a vendor 10, or any of a plurality of further vendors, with required information and creating an account for each vendor that only that particular vendor can log into, in computer memory of a computer server or servers 16 by use of computer software 14. The method may further include registering a human user 2, or any of a plurality of further human users, with required information and creating an account for each user that only the particular user can log into, in computer memory of the computer server or servers 16 by use of computer software 14.

The method may further include receiving a request, at the computer server or servers, from one of the plurality of users, such as the user 2, to subscribe to a particular vendor; determining, by user of computer software 14 on the computer server 16 if the user subscription already exists on the computer server or servers 16, and if not creating a new subscription on the computer server or servers 16 by assigning a newly generated unique identifier that links the particular user to the particular vendor on the computer server or servers 16; and notifying the vendor 10 of the new subscriber through electronic means.

In at least one embodiment, the computer server or servers 16 is programmed by computer software to receive a vendor request whether to allow or not to allow subscribers, and the servers 16 is programmed to allow or not allow subscribers for the particular vendor as requested.

In at least one embodiment, the servers 16 are programmed by computer software 14 which allows a remote vendor 10 to specify whether to automatically approve a subscription or whether each subscription will be manually approved by the vendor 10, and the servers 16 are programmed by computer software to implement the remote vendor 10's requests.

In at least one embodiment, the servers 16 are programmed by computer software to receive and process a request from the vendor 10 specifying a list of personal data that the vendor 10 expects to be disclosed by the user 2 as a condition for subscription. In such a case, the user 2 will be prompted at the client device 4, via data sent by web server 16 via network 8 and through client module 6, about the required data and will have to expressly agree to that data being disclosed to the vendor 10 during the subscription process. The data required could be as simple as first name or something as specific as a tax identification number. In such a case, in at least one embodiment, the user 2, through the client device 4, has the option to decline to disclose the data and opt not to subscribe. The list of personal data items the vendor 10 can require to be disclosed include, but is not limited to, first name, full name, gender, age, date of birth, address, nationality, country of birth, health insurance, education level, tax identification number etc. If a vendor requires any personal data to be disclosed as a condition for subscription, then that data has to be saved by the user on the platform 14 of the web server 16, as part of the user 2 profile. If the required data is not available, the user 2, in at least one embodiment, will not be able to subscribe.

In at least one embodiment, the web server 16 may be programmed by computer software for the platform 14, which receives signals from the vendor 10 via the client device or computer 12, allowing the vendor 10 to specify a set of conditions that need to be fulfilled to allow a user to subscribe. Examples of these conditions include, but are not limited to, the user residing in a particular geographical area (residing in a country, residing with a certain distance of the vendor's address etc.), the user being of a particular gender, the user being in a certain age group, the user having education level above a certain minimum etc.

In at least one embodiment, the computer server 16 may be programmed by computer software for the platform 14 which permits the vendor to charge the user a fee, one time or recurring, for a subscription, such as through electronic payment software.

In at least one embodiment, the computer server 16 may be programmed by computer software for the platform 14 which permits the user 2 through client device 4 and browser computer software 6 to snooze (or put on hold) his/her subscription for a set period of time (e.g. one week, one month, three months, six months, one year, etc.) During the snooze period, the webserver 16 is programmed by computer software for the platform 14, to not allow the vendor 10 to be able to send the subscriber any communication via the platform 14. Once the snooze or pause period, as stored in computer memory of the web server 16, is over, the web server 16 computer software for the platform 14 may have the user's subscription automatically become active again. Additionally, the user 2 may be permitted through computer software of the platform 14 to cancel the pause or snooze at any time.

In at least one embodiment, the computer server 16 is programmed by computer software for platform 14 to allow the user to set a preference (henceforth called MailPreference) in computer memory of the web server 16 that limits the amount of messages sent from the vendor 10 to the user 2 through the platform 14 during a certain period of time. In at least one embodiment, the limit is set as maximum X amount of messages in Y amount of time (e.g. once per week, twice per week, once a month etc.). When a MailPreference is set by the user 2, the platform computer software 14 ensures that it is enforced. As with pausing or snoozing, the user 2 can change or cancel the MailPreference at any time.

In at least one embodiment, the computer web server 16 may be programmed with computer software for the online system 14 so that the vendor 10 is permitted to broadcast messages or other items to all subscribers through the computer software platform 14. When a vendor 10 requests the computer software platform 14 to send a message to all subscribers via the computer software platform 14, the platform 14 will send only to those users that are active, not snoozing and which are within the limits of the MailPreference, if it is set.

In at least one embodiment, the computer web server 16 may be programmed with computer software for the online system 14 so that a user 2 through client device 4 is able to unsubscribe from any vendor 10 anytime and the vendor 10, through client device 12 and computer software of platform 14 can suspend any user subscription at any time, and this will be reflected in stored computer memory in the web server 16. Additionally, the computer web server 16 may be programmed by computer software for the online system 14 so that a user 2 can resubscribe to the vendor 10 at any time so long as the vendor allows resubscription.

In at least one embodiment, the computer server 16 may be programmed with computer software for the online system 14 to allow the vendor 10 send one final ‘goodbye’ message through the online platform computer software 14 to the user 2 via the client device 12, network 8, and the client device 4, after the user unsubscribes.

The specifications' listed characteristics and benefits are not all-inclusive; in particular, a person with ordinary competence in the field would be able to identify a number of additional features and benefits in light of the claims, drawings, and specification. It should also be noted that the terminology used in the specification has mostly been chosen for readability and instructional purposes, and may not have been chosen to delineate or circumscribe the inventive subject matter.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
one or more computer processors; and
one or more computer memories;
wherein the one or more computer memories have stored therein an online system computer software platform;
wherein the one or more computer processors are configured to implement the online system computer software platform;
wherein the online system computer software platform is configured to receive a request from a first user human being to subscribe to a first vendor;
wherein responsive to receiving the request, the online system computer software platform is configured to create a first anonymous subscription to one or more services of the first vendor without revealing, to the first vendor, any identifying information for the first user human being which exists independent of the online system computer software platform;
wherein responsive to creating the first anonymous subscription, the online system software platform is configured to generate a first unique identifier that links the first vendor to the first user human being;
wherein the online system computer software platform is configured to store the first anonymous subscription in computer memory of the online computer software platform;
wherein the online system computer software platform is configured to store the first unique identifier in computer memory of the online computer software platform;
wherein the online system computer software platform is configured to associate, in computer memory of the online computer software platform, the first unique identifier with the anonymous subscription;
wherein the online system computer software platform is configured to receive a first set of one or more communications from the first vendor at the online system computer software platform, wherein the first set of one or more communications include the first unique identifier; and
wherein the online system computer software platform is configured to determine if the first unique identifier is located in the computer memory of the online computer software platform; and
wherein the online system computer software platform is configured so that if the first unique identifier is located in the computer memory of the online computer software platform: (a) the online system computer software platform retrieves data associated with the first user human being from computer memory of the online computer software platform; and (b) stores the first set of one or more communications in an account associated with the first user human being on the online computer software platform.

2. The apparatus of claim 1 wherein
the online system computer software platform is configured so that if the first unique identifier is located in the computer memory of the online system computer software platform, the online system computer software platform sends a first notification to a user computer device through which the first user human being is indicated as being logged in and connected to the online system computer software platform.

3. The apparatus of claim 1 wherein
the online system computer software platform is configured to receive a request from the first user human being to unsubscribe to the first vendor; and responsive to receiving the request from the first user human being to unsubscribe to the first vendor, the online system computer software platform removes the first anonymous subscription to the one or more services of the first vendor and the first unique identifier from the computer memory of the online system computer software platform.

4. A computer software implemented method comprising the steps of:
receiving, at an online system computer software platform executed by computer hardware, a request from a first user human being to subscribe to a first vendor;
responsive to receiving the request, using the online system computer software platform to create a first anonymous subscription to one or more services of the first vendor without revealing, to the first vendor, any identifying information for the first user human being which exists independent of the online system computer software platform;
responsive to creating the first anonymous subscription, generating a first unique identifier that links the first vendor to the first user human being;
storing the first anonymous subscription in computer memory of the online computer software platform;
storing the first unique identifier in computer memory of the online computer software platform;
associating, in computer memory of the online computer software platform, the first unique identifier with the anonymous subscription;
receiving a first set of one or more communications from the first vendor at the online system computer software platform, wherein the first set of one or more communications include the first unique identifier; and
determining if the first unique identifier is located in the computer memory of the online computer software platform; and
if the first unique identifier is located in the computer memory of the online computer software platform: (a) retrieving data associated with the first user human being from computer memory of the online computer software platform; and (b) storing the first set of one or more communications in an account associated with the first user human being on the online computer software platform.

5. The computer software implemented method of claim 4 wherein
if the first unique identifier is located in the computer memory of the online computer software platform, the method further includes sending a first notification to a user computer device through which the first user human being is indicated as being logged in and connected to the online computer software platform.

6. The computer software implemented method of claim 4 further comprising
receiving, at the online system computer software platform executed by the computer hardware, a request from the first user human being to unsubscribe to the first vendor; and
responsive to receiving the request from the first user human being to unsubscribe to the first vendor, using the online system computer software platform to remove the first anonymous subscription to the one or more services of the first vendor and the first unique identifier from the computer memory of the online system computer software platform.

7. A computer software implemented method comprising the steps of:
receiving, at an online system computer software platform executed by computer hardware, a request from a first user human being to subscribe to a first vendor;
responsive to receiving the request, using the online system computer software platform to create, if a first set of predetermined criteria specified by the first vendor and stored in computer memory of the online system computer software platform is met, a first anonymous subscription to one or more services of the first vendor without revealing, to the first vendor, any identifying information for the first user human being which exists independent of the online system computer software platform;
responsive to creating the first anonymous subscription, if the first anonymous subscription was created, generating a first unique identifier that links the first vendor to the first user human being;
storing the first anonymous subscription, if the first anonyomous subscription was created, in computer memory of the online computer software platform;
storing the first unique identifier, if the first anonymous subscription was created, in computer memory of the online computer software platform;
associating, in computer memory of the online computer software platform, the first unique identifier with the anonymous subscription, if the first anonymous subscription was created;
receiving a first set of one or more communications from the first vendor at the online system computer software platform, wherein the first set of one or more communications include the first unique identifier, if the first anonymous subscription was created; and
determining if the first unique identifier is located in the computer memory of the online computer software platform, if the first anonymous subscription was created; and
if the first unique identifier is located in the computer memory of the online computer software platform: (a) retrieving data associated with the first user human being from computer memory of the online computer software platform; and (b) storing the first set of one or more communications in an account associated with the first user human being on the online computer software platform, if the first anonymous subscription was created.

8. The computer software implemented method of claim 7 wherein
the online system computer software platform determines if the first set of predetermined criteria specified by the first vendor and stored in computer memory of the online system computer software platform is met by comparing information from the request from the first user human being with the first set of predetermined criteria.

9. The computer software implemented method of claim 8 wherein
the first set of predetermined criteria includes a requirement that the request include a name for the first user.

10. The computer software implemented method of claim 8 wherein
the first set of predetermined criteria includes a requirement that the request includes and address for the first user.
